(19) United States
(12) Patent Application Publication
(10) Pub. No.: US 2006/0068198 A1
(43) Pub. Date: Mar. 30, 2006

(54) Composite films and process for making the same

(76) Inventors: Dan M. Bratys, Willoughby, OH (US); Richard Bronder, Rochester Hills, MI (US)

Correspondence Address: PPG INDUSTRIES, INC.;Intellectual Property Department, One PPG Place, Pittsburgh, PA, 15272, US

(21) Appl. No.: 11/210,489

(22) Filed: Aug. 24, 2005

Related U.S. Application Data
(60) Provisional application No. 60/606,662, filed on Sep. 2, 2004.
(60) Provisional application No. 60/606,670, filed on Sep. 2, 2004.
(60) Provisional application No. 60/606,638, filed on Sep. 2, 2004.
(60) Provisional application No. 60/606,672, filed on Sep. 2, 2004.
(60) Provisional application No. 60/606,639, filed on Sep. 2, 2004.
(60) Provisional application No. 60/606,661, filed on Sep. 2, 2004.

(51) Int. Cl. B32B 27/40; B32B 27/08

(52) U.S. Cl. 428/337; 428/423.1; 428/423.7; 428/423.5; 428/423.3; 428/424.2

(57) ABSTRACT

A composite article that includes (A) a carrier film having a first and second major surface, and (B) a coating layer superimposed on the first surface of the film. A method for forming a polyurea coating layer on a carrier film includes: (I) selecting: (A) an isocyanate-containing component; and (B) an amine-containing component, where the volume ratio of (A) to (B) is about 1:1, and the equivalent ratio of isocyanate groups to amine groups is greater than 1; (II) mixing (A) and (B) to form a reaction mixture; and (III) applying the reaction mixture to a surface of the carrier film to form a polyurea coating on the carrier film.

### CROSS-REFERENCE TO RELATED APPLICATIONS

This application claims the benefit of priority from U.S. Provisional Patent Application Nos. 60/606,662; 60/606,670; 60/606,638; 60/606,672; 60/606,639; and 60/606,661, all filed Sep. 2, 2004.

### FIELD OF THE INVENTION

The present invention relates to composite films that include a carrier film and a coating layer over a surface of the film, as well as a method of making such films.

### DESCRIPTION OF RELATED ART

Automotive body panels are traditionally made of sheet metal or plastic material painted with layers of pigmented paints. The painting procedure for these panels requires elaborate facilities, and consequently involves heavy expenses. For instance, a large area of floor space must be maintained in a clean room environment for the spraying of paint and for the baking and curing of such paint on the body panels. The paint can include both a pigmented basecoat and transparent clear coat. Moreover, solvent-based paints have come to be considered undesirable in recent years due to environmental concerns. As a consequence, the evaporation of such solvents must be strictly controlled.

A variety of paint composites often referred to as laminates have previously been described. Typically, such composites or laminates have included a paint layer, an adhesive layer adjacent to the paint layer and a carrier film adjacent to the paint layer. The composite is applied to a substrate with the adhesive against the substrate's surface and the carrier layer on the exterior of the composite. Subsequently, the carrier layer can be generally removed or can remain as a protective layer. Patents utilizing such laminate arrangements include, for example, European Patent Application

Also, known in the art are paint composite articles that include a thermally deformable carrier film having an adhesive layer on one surface, a paint layer positioned on the opposed side of the carrier film, and a tiecoat interposed between the carrier film and the paint layer to promote adhesion of the paint layer.

Coating compositions find use in various industries, including the coating and/or painting of motor vehicles. In these industries, and in the automotive industry in particular, considerable efforts have been expended to develop coating compositions with improved performance (both protective and aesthetic) properties. Coatings are used to protect vehicle components against cosmetic damage (e.g., denting, scratching, discoloration, etc.) due to corrosion, abrasion, impacts, chemicals, ultraviolet (UV) light and other environmental exposure. Additionally, color pigmented and high-gloss clear coatings typically further serve as decorative coatings when applied to vehicle body substrates. Multi-component composite coatings (for example, color-plus-clear composite coatings) have been used extensively to these ends. These multi-component coatings may include up to six or more individually applied coating layers over the substrate by one or more coating methods, including either electrophoretic or non-electrophoretic coating methods.

Polyurea elastomers have been among the coating compositions commercially applied to various substrates to provide protection to the substrates and to improve properties of the substrates. Polyurea compositions have been used as protective coatings in industrial applications for coating of process equipment to provide corrosion resistance, or as caulks and sealants in a variety of aggressive environments. In addition, polyurethane elastomers have been used to line rail cars and truck beds. Such coatings for rail cars and trucks provide protection from cosmetic damage as well as protection from corrosion, abrasion, impact damage, chemicals, UV light and other environmental conditions.

Methods of producing sprayable polyurea coatings are disclosed, for example, in U.S. Pat. Nos. 6,013,755; 6,403,752; and 6,613,389. While these methods are generally described as being useful for producing polyurea coatings for automotive surfaces, certain demands of the automotive industry in producing such coatings are not accounted for in those methods.

In the production of a pickup truck bed or bed-liner, the production schedule for manufacture of a pickup truck often requires that the bed-liner composition be applied in a relatively short time frame and that the truck bed to which the bed-liner is applied be handled within minutes of applying the bed-liner. As such, a bed-liner produced from a sprayable polyurea composition must be hardened sufficiently to allow immediate further handling of the truck or truck part. Another possible challenge in applying polyurea compositions as a truck bed-liner can be in the adhesion of the polyurea composition to the truck bed. At the stage of spraying a bed-liner onto a truck, some portions of the truck may have already received conventional automotive coatings such as an electrodeposition coating layer, a primer surfacer, a pigmented basecoat and/or a clear topcoat. The bed-liner can be applied directly to any one of these automotive coatings, each having differing components which might impact the adhesion of a polyurea coating thereto. In addition, the bed-liner properties, including appearance properties, must meet certain predefined criteria for the marketplace.

There is a need in the art to provide composite carrier films that have a durable coating layer on one side and that can be used to protect the finished coated surface of an article, such as the bed of a pickup truck.

### SUMMARY OF THE INVENTION

The present invention is directed to a composite article that includes (A) a carrier film having a first and second major surface and (B) a coating layer superimposed on the first surface of the film, the coating layer formed from a coating composition that contains an isocyanate-containing component and an amine-containing component.

The present invention is also directed to a method of forming a polyurea coating on a carrier film that includes: (I) selecting:
(A) an isocyanate-containing component including an isocyanate-containing material; and
(B) an amine-containing component including an amine-containing material,
where the volume ratio of (A) to (B) is about 1:1, and the equivalent ratio of isocyanate groups to amine groups is greater than 1;
(II) mixing (A) and (B) to form a reaction mixture; and
(III) applying the reaction mixture to a surface of the carrier film to form a polyurea coating on the carrier film.

### DESCRIPTION OF THE DRAWINGS

FIG. 1 is a composite article according to the invention including a metal foil carrier film having a coating layer;

FIG. 2 is a composite article according to the invention including a plastic or synthetic paper carrier film having a coating layer; and

FIG. 3 is a composite article according to the invention including a plastic or synthetic paper carrier film having a coating layer on one side, an adhesive layer on the other side, and a protective layer over the adhesive layer.

### DETAILED DESCRIPTION OF THE INVENTION

Other than in the operating examples or where otherwise indicated, all numbers or expressions referring to quantities of ingredients, reaction conditions, etc., used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

The present invention relates to a composite article that includes (A) a carrier film having a first and second major surface and (B) a coating layer superimposed on the first surface of the film, the coating layer formed from a polyurea coating composition that contains an isocyanate-containing component and an amine-containing component.

Any suitable carrier film can be used in the present invention so long as the coating layer (B) can be superimposed thereon. Suitable carrier films include, but are not limited to, thermoplastic materials, thermoset materials, metal foils, cellulosic paper, synthetic papers, and combinations thereof.

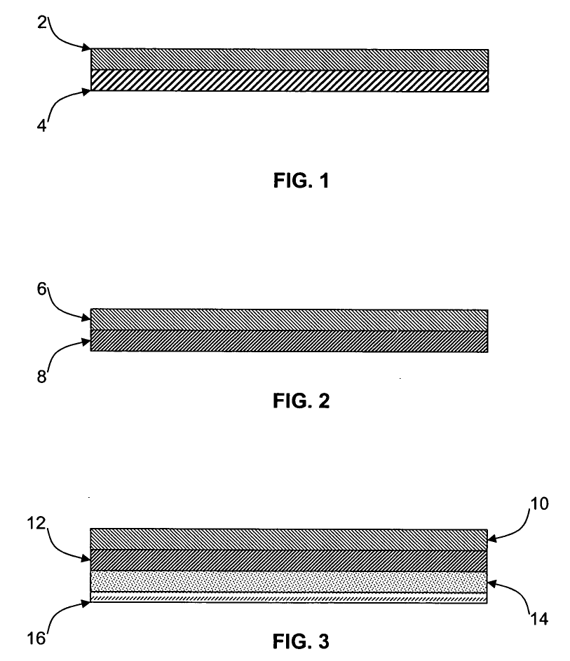

In a further embodiment of the invention, the carrier film includes a suitable metal foil. As used herein, the term “foil” refers to a thin and flexible sheet of metal. Suitable metal foils that can be used in the carrier film of the invention include, but are not limited to, those containing aluminum, iron, copper, manganese, nickel, combinations thereof, and alloys thereof. A particular embodiment of the invention is shown in FIG. 1, where metal foil carrier film 4 is coated by coating layer 2.

In an embodiment of the invention, the carrier film includes a suitable thermoplastic material. As used herein, the term “thermoplastic material” refers to any material that is capable of softening or fusing when heated and of hardening again when cooled. Suitable thermoplastic materials that can be used as the carrier film of the invention include, but are not limited to, those containing polyolefin polymers, polyurethane polymers, polyester polymers, polyamide polymers, polyurea polymers, acrylic polymers, resins, copolymers thereof, and a blend of such materials.

In another embodiment of the invention, the carrier film is made from a suitable thermoset material. As used herein, the term “thermoset material” refers to any material that becomes permanently rigid after being heated and/or cured. Suitable thermoset materials that can be used in the carrier film of the invention include, but are not limited to, those containing polyurethanes, polyesters, polyamides, polyureas, polycarbonates, acrylic polymers, resins, and a blend of such materials.

In an additional embodiment of the invention, the carrier film includes synthetic paper. As used herein, the term “synthetic paper” refers to synthetic plain or calendared sheets that can be coated or uncoated and are made from films containing polypropylene, polyethylene, polystyrene, cellulose esters, polyethylene terephthalate, polyethylene naphthalate, poly 1,4-cyclohexanedimethylene terephthalate, polyvinyl acetate, polyimide, polycarbonate, and combinations and mixtures thereof. The coated papers can include a substrate coated on both sides with film-forming resins such as polyolefin, polyvinyl chloride, etc. The synthetic paper can contain, in suitable combination, various additives; for instance, white pigments such as titanium oxide, zinc oxide, talc, calcium carbonate, etc.; dispersants, for example, fatty amides such as stearamide, etc.; metallic salts of fatty acids such as zinc stearate, magnesium stearate, etc.; pigments and dyes, such as ultramarine blue, cobalt violet, etc.; antioxidants; fluorescent whiteners; and ultraviolet absorbers. Non-limiting example of synthetic papers that can be used in the present invention are those available under the tradename TESLIN®, available from PPG Industries, Inc., Pittsburgh, Pa. and TEDLAR® available from E I DuPont de Nemours and Company, Wilmington, Del.

A particular embodiment of the invention is shown in FIG. 2, where carrier film 8 is a thermoplastic material, a thermoset material or a synthetic paper, which is coated by coating layer 6.

In a particular embodiment of the invention, the carrier film has a film thickness of at least 5 mil (127 μm), in some cases at least 10 mil (254 μm), and in other cases at least 12 mil (305 μm). Also, the carrier film can be up to 50 mil (1270 μm), in some cases up to 40 mil (1016 μm), in other cases up to 30 mil (762 μm), in some situations up to 25 mil (635 μm) and in other situations up to 20 mil (508 μm) thick. The carrier film can be any thickness and can vary and range between any thickness recited above, provided the carrier film can adequately support the coating layer (B) and be sufficiently flexible for a given end use application.

As indicated above, the coating layer is formed from a coating composition that contains an isocyanate-containing component and an amine-containing component. In an embodiment of the invention, the coating composition is a two-component composition where a first component (A) includes the isocyanate-containing material and the second component (B) includes the amine-containing material.

In the present invention, the two-component polyurea coating is formed on a carrier film by:
(I) selecting:
   (A) an isocyanate-containing component including an isocyanate-containing material; and
   (B) an amine-containing component including an amine-containing material,
   where the volume ratio of (A) to (B) is about 1:1, and the equivalent ratio of isocyanate groups to amine groups is greater than 1, such as from 1.03:1 to 1.1:1;
(II) mixing (A) and (B) to form a reaction mixture; and
(III) applying the reaction mixture to a surface of the carrier film to form a polyurea coating on the carrier film.

In an embodiment of the present invention the isocyanate-containing component (A) comprises at least one (poly)isocyanate monomer present in an amount of at least 1 percent by weight, such as at least 2 percent by weight, or at least 4 percent by weight based on the weight of the component (A). In a particular embodiment of the invention, the two-component composition is sprayable, and the present composite article can be made by spraying the coating compositions onto the film. The sprayable polyurea compositions of the present invention are suitable for using a two-component mixing device. Any two-component mixing/application device known in the art can used, for example, static mixture tubes or high pressure impingement mixing/application devices. In a particular embodiment, the compositions of the present invention are suitable for application using a high pressure impingement mixing device in which equal volumes of an isocyanate component and an amine component are impinged upon each other and immediately sprayed onto a substrate to produce a coating. The isocyanate component and the amine component react to produce a polyurea composition which is cured upon application to the substrate. High-pressure impingement mixing is particularly useful in preparing coatings from polymeric systems that have very fast reaction kinetics, such as in the preparation of a polyurea. Polyurea coatings are typically formulated with a stream of an isocyanate component (herein referred to as an A-side) and a stream of an amine component (herein referred to as a B-side). The A-side containing the isocyanate component can be a polyisocyanate monomer, a polyisocyanate prepolymer or a blend of polyisocyanates. A prepolymer is an isocyanate which is prereacted with a sufficient amount of polyamine(s) or other isocyanate reactive components (such as one or more polyols as are well known in the art) so that reactive sites on the polyisocyanate still remain in the prepolymer. Those remaining unreacted sites on the polyisocyanate prepolymer are then available to react further with components in the B-side.

The present invention as described hereafter describes using monomeric polyisocyanates, but this is not meant to be limiting. The present invention encompasses those coating compositions that include polyisocyanate prepolymers, oligomers or blends of polyisocyanates, such as those that include isocyanurate, uretdione, biuret, urethane, allophanate, iminooxadiazine dione, carbodiimide, acylurea and/or oxadiazinetrione groups. Suitable polyisocyanate reactants used on the A-side include isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H12MDI); mixed aralkyl diisocyanates such as tetramethylxylyl diisocyanates; OCN—C(CH₃)₂—C₆H₄C(CH₃)₂—NCO; and polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate. Aliphatic isocyanates are particularly preferred in producing polyurea coatings which are exposed to UV light to avoid degradation. However, in other circumstances less costly, aromatic polyisocyanates can be used when durability is not of significant concern. Examples of aromatic polyisocyanates include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate and alkylated benzene diisocyanates generally; methylene-interrupted aromatic diisocyanates such as methylenediphenyl diisocyanate, especially the 4,4′-isomer (MDI) including alkylated analogs such as 3,3′-dimethyl-4,4′-diphenylmethane diisocyanate and polymeric methylenediphenyl diisocyanate.

The A-side or the B-side can also include inert components such as fillers, stabilizers and pigments.

Amines suitable for use in the composition of the present invention can include primary, secondary, tertiary amines and/or mixtures thereof. The amines can be monoamines, and/or polyamines such as diamines, triamines and higher polyamines and/or mixtures thereof. The amines also can be aromatic or aliphatic (e.g., cycloaliphatic). In one embodiment, the amine component comprises aliphatic amines to provide enhanced durability, where necessary. The amine typically is provided as a liquid having a relatively low viscosity (e.g., less than about 100 mPa·s at 25° C.). In one embodiment, no primary amine is present in the amine component. In a particular embodiment, the amine component is based upon mixtures of primary and secondary amines. For example, if a mixture of primary and secondary amines is employed, the primary amine can be present in an amount of about 20 to 80 wt. %, in some cases about 20 to 50 wt. %, with the balance being secondary amines. Although others can be used, primary amines present in the composition generally have a number average molecular weight (Mn) greater than about 200 (e.g., for reduced volatility), and secondary amines present generally comprise diamines with molecular weights (Mn) of least about 190, in some cases from about 210 to 230.

As used herein, polymer or oligimer molecular weight is determined by gel permeation chromatography (GPC) using appropriate standards, in many cases polystyrene or sulfonated polystyrene.

In one particular embodiment, the amine component includes at least one secondary amine in the amount of 20 to 80 wt. %, in some cases 50 to 80 wt. %. Suitable secondary amines can include, for example, mono and/or poly-functional acrylate or methacrylate modified polyamines, such as aliphatic polyamines. Examples of suitable aliphatic polyamines include, without limitation, ethylamine, the isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

In an another embodiment of the present invention, the secondary amine includes an aliphatic amine, such as a cycloaliphatic diamine. Such amines are available commercially from Huntsman Corporation (Houston, Tex.) under the designation of JEFFLINK™, such as JEFFLINK™ 754. In another embodiment, the amine is provided as an amine-functional resin. Such amine-functional resin is a relatively low viscosity, amine-functional resin suitable for use in the formulation of high solids polyurea coatings. While any of a number of different amine-functional resins are suitable, in an embodiment of the invention, the amine-functional resin includes an ester of an organic acid, for example, an aspartic ester-based amine-functional reactive resin that is compatible with isocyanates (e.g., one that is solvent free, and/or has a mole ratio of amine functionality to the ester of no more than 1:1 so there remains no excess primary amine upon reaction). One example of the polyaspartic esters is the derivative of diethyl maleate and 1,5-diamino-2-methylpentane, available commercially from Bayer Corporation (Pittsburgh, Pa.) under the trade name Desmophen® NH 1220. Other suitable compounds containing aspartate groups can be employed as well. Additionally, the secondary polyamines can include polyaspartic esters which can include derivatives of compounds such as maleic acid, fumaric acid esters, aliphatic polyamines and the like.

The amine component can also include high molecular weight primary amines, such as polyoxyalkyleneamines. The polyoxyalkyleneamines contain two or more primary amino groups attached to a backbone derived, for example, from propylene oxide, ethylene oxide, or a mixture thereof. Examples of such amines include those available under the designation JEFFAMINE® from Huntsman Corporation. Such amines typically have a molecular weight (Mn) ranging from about 200 to about 7500, such as, without limitation, JEFFAMINE® D-230, D400, D-2000, T-403 and T-5000.

According to the process of the present invention, the volume ratio of the isocyanate component to the amine component a mixing/application device is 1:1. This 1:1 volume ratio is selected to ensure proper mixing within a standard mixing device, for example, a standard impingement mixing/application device. One example of a commercially available mixing device accepted for use in the automotive industry is a GUSMER® VH-3000 proportioner fitted with a GUSMER® Model GX-7 spray gun. In that device, pressurized streams of components of the A-side and the B-side are delivered from two separate chambers of a proportioner and are impacted or impinged upon each other at high velocity to effectuate an intimate mixing of the two components and form a polyurea composition which is coated onto the desired substrate via the spray gun. During mixing, the components are atomized and impinged on each other at high pressure. Superior control of the polyurea reaction is achieved when the forces of the component streams are balanced. The mixing forces experienced by the component streams are determined by the volume of each stream entering the mixing chamber per unit time and the pressure at which the component streams are delivered. A 1:1 volume ratio of the components per unit time serves to equalize those forces. A 1:1 volume ratio of isocyanate to amine is particularly critical for the automotive OEM application of sprayable polyurea truck bed-liners.

The coated substrate is then heated to at least partially cure the first coating composition. In the curing operation, solvents are driven off and the film-forming materials are crosslinked. The heating or curing operation is usually carried out at a temperature in the range of from 160-350° F. (71-177° C.) but if needed, lower or higher temperatures may be used as necessary to activate crosslinking mechanisms. Again, if more than one first coating composition is applied to the substrate, curing may be done after the application of each coating layer, or curing of multiple layers simultaneously is possible.

The ratio of equivalents of isocyanate groups to amine groups may be selected to control the rate of cure of the polyurea coating composition, thereby affecting adhesion. It has been found that two-component polyurea compositions capable of being produced in a 1:1 volume ratio have advantages particularly in curing and adhesion to the first coating composition when the ratio of the equivalents of isocyanate groups to amine groups (also known as the reaction index) is greater than one, such as 1.01 to 1.10:1, or 1.03 to 1.10, often 1.05 to 1.08. “Being capable of being produced in a 1:1 volume ratio” means that the volume ratio varies by up to 20% for each component, or up to 10% or up to 5%. The isocyanate-functional component and the amine-functional component can be selected from any of the isocyanates (including polyisocyanates) and amines listed above to provide a reaction index that is greater than one, while being capable of being applied in a 1:1 volume ratio and acceptable performance of the resulting coating. In some instances, a desired physical property of a polyurea coating composition for a truck bed-liner is surface texture. Surface texture can be created by first spraying the polyurea composition onto the first coating composition to produce a smooth, substantially tack-free first layer. By “substantially tack-free” is meant the condition wherein upon gently touching the surface of the layer with a loose fitting glove, the glove tip does not stick to, or otherwise adhere to, the surface as determined by the Tack-Free Method. The Tack-Free Method provides that the coating composition is sprayed in one coat onto a non-adhering plastic sheet typically in a thickness of 10-15 mils (254 to 381 microns). When spraying is complete, an operator, using a loose fitting, disposable vinyl glove, such as one commercially available under the trade name Ambidex Disposable Vinyl Glove by Marigold Industrial, Norcross Ga., gently touches the surface of the coating. The coating may be touched more than one time by using a different fingertip. When the glove tip no longer sticks to, or must be pulled from, the surface of the layer, the surface is said to be substantially tack-free. A time beginning from the completion of spraying until when the layer is substantially tack-free is said to be the tack-free time.

An excess of polyisocyanate monomer can decrease the viscosity of the polyurea composition, as well as allowing for improved flow over the substrate. The cured coatings which have previously been applied to automotive surfaces can comprise functional groups that are reactive to isocyanates (e.g. hydroxyl groups), thereby enhancing adhesion of the sprayed polyurea composition to the substrate surface. A lower viscosity polyurea composition also keeps the composition in a flowable state for a longer period of time.

In some instances, a desired physical property of a polyurea coating composition for a truck bed-liner is surface texture. Surface texture can be created by first spraying the polyurea composition onto the first coating composition to produce a smooth, substantially tack-free first layer as described above. The tack-free time and the cure time for the polyurea composition may be controlled by balancing levels of various composition components, for example, by balancing the ratio of primary amine to secondary amines. A second or subsequent layer of the polyurea composition then can be applied to the first layer as a texturizing layer or “dust coating”. This may be accomplished, for example, by increasing the distance between the application mixing device and the coated substrate to form discrete droplets of the polyurea composition prior to contacting the coated substrate thereby forming controlled non-uniformity in the surface of the second layer. The substantially tack-free first layer of the polyurea coating is at least partially resistant to the second polyurea layer; i.e., at least partially resistant to coalescence of the droplets of polyurea composition sprayed thereon as the second polyurea layer or dust coating, such that the droplets adhere to, but do not coalesce with, the first layer to create surface texture. Typically the second polyurea layer exhibits more surface texture than the first polyurea layer. An overall thickness of the two polyurea layers may range from 20 to 120 mils, such as from 40 to 110 mils, or from 60 to 100 mil (1524-2540 microns) with the first layer being one half to three quarters of the total thickness (762-1905 microns) and the dust coating being one fourth to one half of the total thickness (381-1270 microns). Note further that each layer of the polyurea coating may be deposited from different compositions. In one embodiment, the first layer is deposited from a polyurea composition comprising an aromatic amine component and an aromatic polyisocyanate component, while the second layer is deposited from a polyurea composition comprising an aliphatic amine component and an aliphatic polyisocyanate component. It should be noted that the “first” polyurea coating layer may comprise one, two, three or more layers, and the “second” polyurea coating layer may be one or more subsequent layers applied thereover. For example, in one embodiment of the present invention four polyurea layers may be applied, with the fourth layer being the dust coating, with each layer having a thickness ranging from 15 to 25 mil (381-635 microns).

The polyurea composition can contain a silica and/or a clay. The polyurea composition can also include-one or more additives, for example, a light stabilizer, thickener, pigment, fire retardant, adhesion promoter, catalyst or other performance or property modifiers. Such additives are typically provided in the A-side but can instead be provided in the B-side or in both.

Suitable tertiary amines for use as adhesions promoters include 1,5-diazabicyclo[4.3.0]non-5-ene, 1,8-diazabicyclo[5.4.0]undec-7-ene, 1,4-diazabicyclo[2.2.2]octane, 1,5,7-triazabicyclo[4.4.0]dec-5-ene, and 7-methyl-1,5,7-triazabicyclo[4.4.0]dec-5-ene. An example of an amino silane for use as an adhesion promoter is γ-aminopropyltriethoxysilane (commercially available as Silquest A100 from OSY Specialties, Inc.). Other suitable amine-functional adhesion promoters include 1,3,4,6,7,8-hexahydro-2H-pyrimido-(1,2-A)-pyrimidine, hydroxyethyl piperazine, N-aminoethyl piperizine, dimethylamine ethylether, tetramethyliminopropoylamine (commercially available as Polycat® 15 from Air Products and Chemicals, Inc., blocked amines such as an adduct of IPDI and dimethylamine, a melamine such as melamine itself or an imino melamine resin (e.g. Cymel®) 220 or Cymel® 303, available from Cytec Industries Inc.). Metal-containing adhesion promoters may include metal chelate complexes such as an aluminum chelate complex (e.g. K-Kat 5218 available from King Industries) or tin-containing compositions such as stannous octoate. Other adhesion promoters may include salts such as chlorine phosphate, butadiene resins such as an epoxidized, hydroxyl terminated polybutadiene resin (e.g. Poly bd® 605E available from Atofina Chemicals, Inc.), polyester polyols (e.g. CAPA® 3091, a polyester triol available from Solvay America, Inc., and urethane acrylate compositions such as an aromatic urethane acrylate oligomer (e.g. CN999 available from Sartomer Company, Inc.).

In an embodiment of the invention, the composition may further comprise a clay and, optionally a silica. When the coating composition contains a clay and/or a silica, components (A) and (B) can be substantially free of other adhesion promoting materials. Any suitable clay or silica can be used in the coating composition. Suitable clays include, but are not limited to, montmorillonite clays, kaolin clays, attapulgite clays, sepiolite clay, and mixtures thereof. In a particular embodiment, the clay includes bentonite. In another particular embodiment, the silica includes fumed silica. In a further particular embodiment, the clay and/or silica can be surface treated.

In an embodiment of the invention, the carrier film includes an adhesive layer superimposed on the second surface of the film. Any suitable adhesive composition known in the art can be used to form the adhesive layer. Suitable adhesive compositions include epoxy adhesives, urethane adhesives, and those that contain an acrylic latex polymer prepared from a monomer composition that includes C₁-C₅ linear, branched, or cyclic alkyl (meth)acrylate monomers.

In a further embodiment, a temporary protective cover is superimposed over the adhesive layer. Any suitable material can be used as the protective cover. Suitable materials include, but are not limited to, paper and polymeric materials.

A particular embodiment of the invention is shown in FIG. 3, where carrier film 12 is a thermoplastic material, a thermoset material, or a synthetic paper, which is coated on a first side by coating layer 10. Adhesive layer 14 is coated on a second side of carrier film 12, which is in turn covered by protective layer 16.

As indicated above, the present invention provides a method of forming a polyurea coating on a carrier film that includes (I) selecting (A) an isocyanate-containing component including an isocyanate-containing material, and (B) an amine-containing component including an amine-containing material; (II) mixing (A) and (B) to form a reaction mixture; and (III) applying the reaction mixture to a substrate to form a polyurea coating on the carrier film. The polyurea coating component (A) and (B) can be selected from and of those previously described.

In an embodiment of the invention, the mixing is accomplished by impingement and the reaction mixture is applied to the substrate by spraying.

In a further embodiment, the reaction mixture at least partially cures to form a tack-free polyurea coating and a second polyurea coating is applied over the at least partially cured polyurea coating. In a particular embodiment, the partially cured polyurea coating is resistant to the second coating. In an additional embodiment of the invention, the second coating exhibits more surface texture than the first coating.

In an embodiment of the invention, the carrier film can be coated with two or more coating layers superimposed on the first surface of the film, where at least one coating layer is formed from the above-described coating composition containing an isocyanate-containing component and an amine-containing component and one or more coating layers formed from a different coating composition.

As a non-limiting example, a first coating layer can be applied, followed by a coating layer formed from the above-described coating composition to form a multi-component composite coating. The first coating composition used in the formation of the first coating layer of the multi-component composite coating of the present invention may be selected from primer compositions, pigmented or non-pigmented monocoat compositions, pigmented base coat compositions, transparent topcoat compositions, industrial coating compositions, and other coatings commonly used to coat carrier films as described above.

The first coating composition often comprises a multi-layer coating formed from combinations of at least two of the above-mentioned coating compositions. Alternatively, the first coating composition may be a single composition applied directly to a carrier film substrate that optionally has been pretreated, or to a substrate that has been coated previously with one or more protective and/or decorative coatings. The second coating composition may be applied directly over any of the compositions indicated above as the first coating composition.

The first coating composition typically comprises a crosslinking agent that may be selected, for example, from aminoplasts, polyisocyanates including blocked isocyanates, polyepoxides, beta-hydroxyalkylamides, polyacids, anhydrides, organometallic acid-functional materials, polyamines, polyamides and mixtures of any of the foregoing.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. For example, aldehyde condensates of glycoluril, which yield a high melting crystalline product useful in powder coatings, can be used. Formaldehyde is the most commonly used aldehyde, but other aldehydes such as acetaldehyde, crotonaldehyde and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol and hexanol can be employed for this purpose. Nonlimiting examples of suitable aminoplast resins are commercially available from Cytec Industries, Inc. under the trademark CYMEL® and from Solutia, Inc. under the trademark RESIMENE®. Particularly useful aminoplasts include CYMEL® 385 (suitable for water-based compositions), CYMEL® 1158 imino-functional melamine formaldehyde condensates, and CYMEL® 303.

Other crosslinking agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Although higher polyisocyanates such as isocyanurates of diisocyanates are often used, diisocyanates can also be used. Isocyanate prepolymers, for example reaction products of polyisocyanates with polyols also can be used. Mixtures of polyisocyanate crosslinking agents can be used.

The polyisocyanate which is utilized as a crosslinking agent can be prepared from a variety of isocyanate-functional materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

If the polyisocyanate is to be blocked or capped, any suitable aliphatic, cycloaliphatic or aromatic alkyl monoalcohol known to those skilled in the art can be used as a capping agent for the polyisocyanate. Examples of suitable blocking agents include those materials which would unblock at elevated temperatures, such as lower aliphatic alcohols including methanol, oximes such as methyl ethyl ketoxime, lactams such as caprolactam and pyrazoles such as dimethylpyrazole.

Polyepoxides are suitable curing agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl) adipate. Higher molecular weight polyepoxides, including the polyglycidyl ethers of polyhydric phenols and alcohols described below, are also suitable as crosslinking agents.

Beta-hydroxyalkylamides are suitable curing agents for polymers having carboxylic acid groups. The beta-hydroxyalkylamides can be depicted structurally as follows: 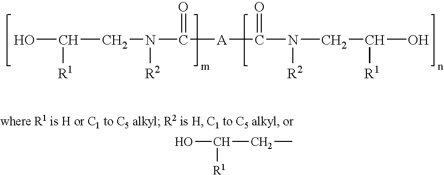
where R¹ is as described above; A is a bond or a polyvalent organic radical derived from a saturated, unsaturated or aromatic hydrocarbon including substituted hydrocarbon radicals containing from 2 to 20 carbon atoms; m is equal to 1 or 2; n is equal to 0 or 2, and m+n is at least 2, usually within the range of from 2 up to and including 4. Most often, A is a C₂ to C₁₂ divalent alkylene radical.

Polyacids, particularly polycarboxylic acids, are suitable as curing agents for polymers having epoxy functional groups. Examples of suitable polycarboxylic acids include adipic, succinic, sebacic, azelaic and dodecanedioic acid. Other suitable polyacid crosslinking agents include acid group-containing acrylic polymers prepared from an ethylenically unsaturated monomer containing at least one carboxylic acid group and at least one ethylenically unsaturated monomer that is free from carboxylic acid groups. Such acid functional acrylic polymers can have an acid number ranging from 30 to 150. Acid functional group-containing polyesters can be used as well. Low molecular weight polyesters and half-acid esters can be used which are based on the condensation of aliphatic polyols with aliphatic and/or aromatic polycarboxylic acids or anhydrides. Examples of suitable aliphatic polyols include ethylene glycol, propylene glycol, butylene glycol, 1,6-hexanediol, trimethylol propane, di-trimethylol propane, neopentyl glycol, 1,4-cyclohexanedimethanol, pentaerythritol, and the like. The polycarboxylic acids and anhydrides may include, inter alia, terephthalic acid, isophthalic acid, phthalic acid, phthalic anhydride, tetrahydrophthalic acid, tetrahydrophthalic anhydride, hexahydrophthalic anhydride, methylhexahydrophthalic anhydride, chlorendic anhydride, and the like. Mixtures of acids and/or anhydrides may also be used. The above-described polyacid crosslinking agents are described in further detail in U.S. Pat. No. 4,681,811 at column 6, line 45 to column 9, line 54, which is incorporated herein by reference.

Useful organometallic complexed materials which can be used as crosslinking agents include a stabilized ammonium zirconium carbonate solution commercially available from Magnesium Elektron, Inc. under the trademark BACOTE™ 20, stabilized ammonium, zirconium carbonate, and a zinc-based polymer crosslinking agent commercially available from Ultra Additives Inc. under the trademark ZINPLEX® 15.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Suitable polyamide crosslinking agents include those derived from fatty acids or dimerized fatty acids or polymeric fatty acids and aliphatic polyamines. For example, the materials commercially available from Henkel Corporation under the trademark designations VERSAMID® 220 or 125 are quite useful herein.

Appropriate mixtures of crosslinking agents may also be used in the invention. The amount of the crosslinking agent in the first coating composition generally ranges from 5 to 75 percent by weight based on the total weight of resin solids (crosslinking agent plus film-forming resin) in the first coating composition.

The first coating composition further comprises at least one film-forming resin having functional groups that are reactive with the crosslinking agent. The film-forming resin in the first coating composition may be selected from any of a variety of polymers well known in the art. In an embodiment of the invention, the film-forming resin can be selected from acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art where the polymers are water dispersible, emulsifiable or of limited water solubility. The functional groups on the film-forming resin in the first coating composition may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups), mercaptan groups, and combinations thereof.

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and preferably 4 to 18, carbon atoms in the alkyl group. Non-limiting examples include methyl methacrylate, ethyl methacrylate, butyl methacrylate, ethyl acrylate, butyl acrylate and 2-ethyl hexyl acrylate. other suitable copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride; and vinyl esters such as vinyl acetate.

The acrylic copolymer can include hydroxyl functional groups, which are often incorporated into the polymer by including one or more hydroxyl functional monomers in the reactants used to produce the copolymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxy functional adducts of caprolactone and hydroxyalkyl acrylates, and corresponding methacrylates, as well as the beta-hydroxy ester functional monomers described below. The acrylic polymer can also be prepared with N-(alkoxymethyl)acrylamides and N-(alkoxymethyl)methacrylamides.

Beta-hydroxy ester functional monomers can be prepared from ethylenically unsaturated, epoxy functional monomers and carboxylic acids having from 13 to 20 carbon atoms, or from ethylenically unsaturated acid functional monomers and epoxy compounds containing at least 5 carbon atoms which are not polymerizable with the ethylenically unsaturated acid functional monomer.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Examples of carboxylic acids include, but are not limited to, saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, preferably containing from 8 to 30 carbon atoms, such as butyl glycidyl ether, octyl glycidyl ether, phenyl glycidyl ether and para-(tertiary butyl) phenyl glycidyl ether. Particular glycidyl esters include those of the structure: 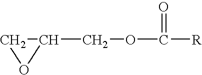
where R is a hydrocarbon radical containing from 4 to 26 carbon atoms. Typically, R is a branched hydrocarbon group having from 8 to 10 carbon atoms, such as neopentanoate, neoheptanoate or neodecanoate. Suitable glycidyl esters of carboxylic acids include VERSATIC ACID 911 and CARDURA® E, each of which are commercially available from Resolution Performance Products LLC.

Carbamate functional groups can be included in the acrylic polymer by copolymerizing the acrylic monomers with a carbamate functional vinyl monomer, such as a carbamate functional alkyl ester of methacrylic acid, or by reacting a hydroxyl functional acrylic polymer with a low molecular weight carbamate functional material, such as can be derived from an alcohol or glycol ether, via a transcarbamoylation reaction. Alternatively, carbamate functionality may be introduced into the acrylic polymer by reacting a hydroxyl functional acrylic polymer with a low molecular weight carbamate functional material, such as can be derived from an alcohol or glycol ether, via a transcarbamoylation reaction. In this reaction, a low molecular weight carbamate functional material derived from an alcohol or glycol ether is reacted with the hydroxyl groups of the acrylic polyol, yielding a carbamate functional acrylic polymer and the original alcohol or glycol ether. The low molecular weight carbamate functional material derived from an alcohol or glycol ether may be prepared by reacting the alcohol or glycol ether with urea in the presence of a catalyst. Suitable alcohols include lower molecular weight aliphatic, cycloaliphatic and aromatic alcohols such as methanol, ethanol, propanol, butanol, cyclohexanol, 2-ethylhexanol and 3-methylbutanol. Suitable glycol ethers include ethylene glycol methyl ether and propylene glycol methyl ether. Propylene glycol methyl ether and methanol are most often used. Other carbamate functional monomers as known to those skilled in the art may also be used.

Amide functionality may be introduced to the acrylic polymer by using suitably functional monomers in the preparation of the polymer, or by converting other functional groups to amido groups using techniques known to those skilled in the art. Likewise, other functional groups may be incorporated as desired using suitably functional monomers if available, or conversion reactions as necessary.

Acrylic polymers can be prepared via aqueous emulsion polymerization techniques and used directly in the preparation of aqueous coating compositions, or can be prepared via organic solution polymerization techniques for solventborne compositions. When prepared via organic solution polymerization with groups capable of salt formation such as acid or amine groups, upon neutralization of these groups with a base or acid the polymers can be dispersed into aqueous medium. Generally, any method of producing such polymers that is known to those skilled in the art utilizing art recognized amounts of monomers can be used.

Besides acrylic polymers, the polymeric film-forming resin in the first coating composition may be an alkyd resin or a polyester. Such polymers may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid and trimellitic acid. Besides the polycarboxylic acids mentioned above, functional equivalents of the acids such as anhydrides where they exist, or lower alkyl esters of the acids such as the methyl esters, may be used. Where it is desired to produce air-drying alkyd resins, suitable drying oil fatty acids may be used and include, for example, those derived from linseed oil, soya bean oil, tall oil, dehydrated castor oil or tung oil.

Likewise, polyamides may be prepared utilizing polyacids and polyamines. Suitable polyacids include those listed above and polyamines may be selected from at least one of ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane.

Carbamate functional groups may be incorporated into the polyester or polyamide by first forming a hydroxyalkyl carbamate which can be reacted with the polyacids, and polyols/polyamines used in forming the polyester or polyamide. The hydroxyalkyl carbamate is condensed with acid functionality on the polymer, yielding terminal carbamate functionality. Carbamate functional groups may also be incorporated into the polyester by reacting terminal hydroxyl groups on the polyester with a low molecular weight carbamate functional material via a transcarbamoylation process similar to the one described above in connection with the incorporation of carbamate groups into the acrylic polymers, or by reacting isocyanic acid with a hydroxyl functional polyester.

Other functional groups such as amine, amide, thiol and urea may be incorporated into the polyamide, polyester or alkyd resin as desired, using suitably functional reactants if available, or conversion reactions as necessary to yield the desired functional groups. Such techniques are known to those skilled in the art.

Polyurethanes can also be used as the polymeric film-forming resin in the first coating composition. Among the polyurethanes which can be used are polymeric polyols which generally are prepared by reacting the polyester polyols or acrylic polyols such as those mentioned above with a polyisocyanate such that the OH/NCO equivalent ratio is greater than 1:1 so that free hydroxyl groups are present in the product. The organic polyisocyanate which is used to prepare the polyurethane polyol can be an aliphatic or an aromatic polyisocyanate or a mixture of the two. Diisocyanates are typically used, although higher polyisocyanates can be used in place of or in combination with diisocyanates. Examples of suitable aromatic diisocyanates are 4,4′-diphenylmethane diisocyanate and toluene diisocyanate. Examples of suitable aliphatic diisocyanates are straight chain aliphatic diisocyanates such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates are 1,2,4-benzene triisocyanate and polymethylene polyphenyl isocyanate. As with the polyesters, the polyurethanes can be prepared with unreacted carboxylic acid groups which, upon neutralization with bases such as amines, allow for dispersion into aqueous medium.

Terminal and/or pendant carbamate functional groups can be incorporated into the polyurethane by reacting a polyisocyanate with a polymeric polyol containing the terminal/pendant carbamate groups. Alternatively, carbamate functional groups can be incorporated into the polyurethane by reacting a polyisocyanate with a polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate-functional polyurethane can be reacted with a hydroxyalkyl carbamate to yield a carbamate functional polyurethane.

Other functional groups such as amide, thiol and urea may be incorporated into the polyurethane as desired using suitably functional reactants if available, or conversion reactions as necessary to yield the desired functional groups. Such techniques are known to those skilled in the art.

Examples of polyether polyols are polyalkylene ether polyols which include those having the following structural formula: 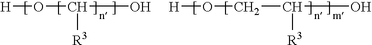
where the substituent R³ is hydrogen or lower alkyl containing from 1 to 5 carbon atoms including mixed substituents, n′ is typically from 2 to 6 and m′ is from 8 to 100 or higher. Included are poly(oxytetramethylene) glycols, poly(oxytetraethylene) glycols, poly(oxy-1,2-propylene) glycols and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE® and TERACOL®, available from E. I. Du Pont de Nemours and Company, Inc., and POLYMEG®, available from Q O Chemicals, Inc., a subsidiary of Great Lakes Chemical Corp.

Pendant carbamate functional groups may be incorporated into the polyethers by a transcarbamoylation reaction. Other functional groups such as acid, amine, epoxide, amide, thiol and urea may be incorporated into the polyether as desired using suitably functional reactants if available, or conversion reactions as necessary to yield the desired functional groups.

The polyether polymer typically has a number average molecular weight of from 500 to 5000, more often from 1100 to 3200, as determined by gel permeation chromatography using a polystyrene standard, and an equivalent weight of within the range of 140 to 2500, often 500, based on equivalents of reactive pendant or terminal groups. The equivalent weight is a calculated value based on the relative amounts of the various ingredients used in making the polyether polymer and is based on solids of the polyether polymer.

Suitable epoxy functional polymers for use as the film-forming resin in the first coating composition may include a polyepoxide chain extended by reacting together a polyepoxide and a polyhydroxyl group-containing material selected from alcoholic hydroxyl group-containing materials and phenolic hydroxyl group-containing materials to chain extend or build the molecular weight of the polyepoxide.

A chain extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of 80° C. to 160° C. for 30 to 180 minutes until an epoxy group-containing resinous reaction product is obtained.

The equivalent ratio of reactants, i.e., epoxy:polyhydroxyl group-containing material is typically from 1.00:0.75 to 1.00:2.00.

The polyepoxide by definition has at least two 1,2-epoxy groups. In general, the epoxide equivalent weight of the polyepoxide will range from 100 to 2000, typically from 180 to 500. The epoxy compounds may be saturated or unsaturated, cyclic or acyclic, aliphatic, alicyclic, aromatic or heterocyclic. They may contain substituents such as halogen, hydroxyl and ether groups.

Examples of polyepoxides are those having a 1,2-epoxy equivalency greater than one and usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as those disclosed above.

Epoxy functional film-forming resins used in the first coating composition may alternatively be acrylic polymers prepared with epoxy functional monomers such as glycidyl acrylate, glycidyl methacrylate, allyl glycidyl ether and methallyl glycidyl ether. Polyesters, polyurethanes or polyamides prepared with glycidyl alcohols or glycidyl amines, or reacted with an epihalohydrin, are also suitable epoxy functional resins.

Appropriate mixtures of film-forming resins may also be used in the multi-component composite coating of the present invention. The amount of the film-forming resin in the first coating composition generally ranges from 25 to 95 percent by weight based on the total weight of resin solids in the first coating composition.

If desired, any of the coating compositions described above can include other optional materials well known in the art of formulated surface coatings, such as plasticizers, antioxidants, hindered amine light stabilizers, UV light absorbers and stabilizers, surfactants, flow control agents, thixotropic agents such as bentonite clay, pigments, fillers, organic cosolvents, catalysts, including phosphoric acids and other customary auxiliaries. These materials can constitute up to 40 percent by weight of the total weight of the coating composition.

The first coating composition can be applied to the substrate by conventional means including brushing, dipping, flow coating, spraying, and the like. The usual spray techniques and equipment for air spraying and electrostatic spraying and either manual or automatic methods can be also be used for application of the first coating composition to the substrate.

After application of the first coating composition to the substrate, a film is formed on the surface of the substrate by driving water and/or organic solvents out of the film (flashing) by heating or by an air-drying period. If more than one first coating composition is applied to the substrate, flashing may be done after the application of each coating layer.

The coated substrate is then heated to at least partially cure the first coating composition. In the curing operation, solvents are driven off and the film-forming materials are crosslinked. The heating or curing operation is usually carried out at a temperature in the range of from 160-350° F. (71-177° C.) but, if needed, lower or higher temperatures may be used as necessary to activate crosslinking mechanisms. Again, if more than one first coating composition is applied to the substrate, curing may be done after the application of each coating layer, or curing of multiple layers simultaneously is possible.

The second coating composition is applied over at least a portion of the first coating. The above-described sprayable polyurea compositions used as the second coating composition in the multi-component composite coating of the present invention typically are two-component compositions including, as described above, an isocyanate-functional component and an amine-functional component.

In some instances, a desired physical property of a polyurea coating composition for a truck bed-liner is surface texture. Surface texture can be created by first spraying the above-described polyurea composition onto the first coating composition to produce a smooth, substantially tack-free first layer. By “substantially tack-free” is meant that a latex glove worn on an observer's hand does not stick to the coating after lightly touching the coating.

The tack-free time and the cure time for the polyurea composition may be controlled by balancing the ratio of primary amine to secondary amines in the above-described second component. A second layer of the above-described polyurea composition then can be applied to the first layer as a texturizing layer or “dust coating.” This may be accomplished, for example, by increasing the distance between the impingement mixing device and the coated substrate to form discrete droplets of the polyurea composition prior to contacting the coated substrate, thereby forming controlled non-uniformity in the surface of the second layer.

The substantially tack-free first layer of the polyurea coating is at least partially resistant to the second polyurea layer, i.e., at least partially resistant to coalescence of the droplets of polyurea composition sprayed thereon as the second polyurea layer or dust coating, such that the droplets adhere to, but do not coalesce with, the first layer to create surface texture. Typically, the second polyurea layer exhibits more surface texture than the first polyurea layer.

An overall thickness of the two polyurea layers may range from 70 to 100 mil (1778-2540 microns) with the dust coating being one fourth to one third of the total thickness. Note further that each layer of the polyurea coating may be deposited from different compositions. In one embodiment, the first layer is deposited from a polyurea composition comprising an aromatic amine component and an aromatic polyisocyanate component, while the second layer is deposited from a polyurea composition comprising an aliphatic amine component and an aliphatic polyisocyanate component.

The above-described polyurea composition may also include one or more additives, for example, a light stabilizer, thickener, pigment, fire retardant, catalyst or other performance or property modifiers. Such additives are typically provided in the A-side but may instead be provided in the B-side or in both.

In a particular embodiment of the present invention, the amine-functional component (B-side) further comprises a clay and, optionally, a silica. In this embodiment, a coating layer formed from the two-component polyurea coating composition over a surface of a carrier film substrate has been found to have better adhesion to the carrier film substrate than a similar coating composition without a clay or a silica.

The present invention is more particularly described in the following examples, which are intended to be illustrative only, since numerous modifications and variations therein will be apparent to those skilled in the art. Unless otherwise specified, all parts and percentages are by weight.

### EXAMPLE 1

A polyurea composition was produced from the formulation in Table 1 by mixing a 1:1 volume ratio of the A-side components to the B-side components using a H₂O/35-35-10 Proportioning Unit and GX-7 spray gun (a high-pressure impingement mixing device) manufactured by Gusmer Corporation, Lakewood, N.J. and applied over TESLIN® (synthetic printing sheet available from PPG Industries Inc., Pittsburgh, Pa.) at film thicknesses of 20, 40 and 60 mils.

TABLE I
Component

| A-side | |
|---|---|
| Isophorone diisocyanate | 26.8 |
| DESMODUR ® N3400¹ | 50.0 |
| TERATHANE ® 650² | 20.8 |
| 1,2-butanediol | 1.2 |
| Neopentyl glycol | 1.2 |
| B-side | |
| JEFFAMINE ® T-3000³ | 33.8 |
| DESMOPHEN ® NH 1220⁴ | 29.8 |
| JEFFLINK ™ 754⁵ | 31.1 |
| IRGANOX ® 1135⁶ | 0.02 |
| TINUVIN ® 328⁷ | 0.02 |
| (benzotriole UV absorber) | |
| Molecular sieve Type 3A | 0.5 |
| (Potassium/sodium aluminate) | |
| AEROSIL ® 200⁸ | 1.75 |
| Z-6020 Silane⁹ | 0.02 |
| VULCAN ® XC-72R¹⁰ | 1.2 |
| Bentone ®¹¹ | 1.74 |

¹diisocyanate available from Bayer Material Science, Pittsburgh, PA
²polyether glycolavailable from E I DuPont de Nemours and Company. Wilimington, DE
³polyoxyalkylene primary amine available from Huntsman Corp., Houston, TX
⁴amine-functional aspartic acid ester available from Bayer Material Science
⁵alicyclic secondary amine available from Huntsman Corp.
⁶hindered phenolic antioxidant, Ciba Specialty Chemicals, Basel, Switzerland
⁷benzotriole UV absorber, Ciba Specialty Chemicals
⁸silicon dioxide, Degussa AG, Dusseldorf, Germany
⁹amino silane, Dow Corning Corp., Midland, Michigan
¹⁰carbon black, Cabot., Boston, MA
¹¹bentonite clay, NL Industries, Inc., New York, NY

The A-side components were premixed and charged into one holding chamber of the mixing device. The B-side was prepared by preparing a prepolymer by mixing the IPDI, terathane, butanediol, and neopentyl glycol under nitrogen. A catalytic amount of dibutyl tin dilaurate (DBTL) was added and the mixture was stirred for 15 minutes. The reaction mixture was first heated to 40° C. and then to 100° C. The resulting prepolymer was cooled to 80° C. and poured into 95% of the Desmodur N3400 and stirred for 15 minutes. Additional Desmodur N3400 was added to adjust the isocyanate equivalent weight. The ratio of equivalents of isocyanate to amine was calculated as being 1.08.

Specific spray conditions for application included a material temperature of 140° F. (60° C.), flow rate of 0.9 gpm for basecoat and 0.8 gpm for dustcoat using Gusmer spray tip 213 for basecoat and Gusmer spray tip 212.5 for dustcoat at a system pressure of 800 psi for basecoat and 700 psi for dustcoat. The 20 mil film was applied with one coat of basecoat and 6 passes of dustcoat, the 40 mil film was applied with two coats of basecoat and 9 passes of dustcoat, and the 60 mil film was applied with four coats of basecoat and 9 passes of dustcoat

### EXAMPLE 2

Another set of samples were prepared as described in example 1, using TEDLAR® PVF, available from E I DuPont de Nemours and Company. Wilmington, Del., as the substrate.

The films were tested for humidity resistance, 240 hours at 60° C. and 95% RH (film passes if no bubble formation or separation from the substrate), watersoak resistance, submersion for 240 hours at 50° C. (film passes if no bubble formation or separation from the substrate), and heat resistance for 500 hours at 90° C. (film passes if no bubble formation or separation from the substrate).

The coated TEDLAR samples were evaluated as follows.

### Thermal Resistance

Samples are placed in a constant temperature chamber at 90° C. for 500 hours. Control samples are held at 20° C. To pass, samples must exhibit no chalking, cracking, swelling, blisters, discoloration or visible adhesion failure.

### Hot Water Resistance

Samples are held vertically in a constant temperature water bath at 40±1° C. for 500 hours. To pass, samples must exhibit no chalking, cracking, swelling, blisters, discoloration or visible adhesion failure.

### Humidity Resistance

Samples are maintained at a 45 angle in an environmental chamber at 50±1° C., 95% RH, for 240 hours. To pass, samples must exhibit no chalking, cracking, swelling, blisters, discoloration or visible adhesion failure.

### Heat Cycle Resistance

Samples are maintained vertically in an environmental chamber and exposed to environmental cycles of 90±2° C., 20% RH, for 4 hours, ambient conditions (20±1° C.) for 0.5 hours, −40±2° C. for 1.5 hours, ambient conditions for 0.5 hours, 70±2° C., 95% RH for 3 hours, ambient conditions for 0.5 hours, 40±2° C. for 1.5 hours, ambient conditions for 0.5 hours and then back to the beginning of the cycle. The cycle is repeated 10 times. To pass, samples must exhibit no chalking, cracking, swelling, blisters, discoloration or visible adhesion failure.

### Impact Resistance

The sample was placed on an anvil with the coating side facing up. A tube, 50 cm high was placed over a spot on the sample. A steel ball weighing 500 g was dropped 50 cm through the tube so that it would strike the surface of the coating. The procedure was repeated three times at 23±1° C. and three times at −40±1° C. Passing requires no damage to the surface of the coating.

Each test above was performed on separate coated TEDLAR samples with the following results:

| | Humidity | Hot Water | |
|---|---|---|---|
| | Test | Test | Thermal Test |
| 20 mil film | Pass | Pass | Pass |
| 40 mil film | Pass | Pass | Pass |
| 60 mil film | Pass | Pass | Pass |

| | | Impact Test | Impact Test |
|---|---|---|---|
| | Heat Cycle | (23° C.) | (−40° C.) |
| 20 mil film | Pass | Pass | Pass |
| 40 mil film | Pass | Pass | Pass |
| 60 mil film | Pass | Pass | Pass |

### EXAMPLE 3

A 40 mil film was applied to a TESLIN substrate as described in example 1. Samples of the coated TESLIN were then glued to electrocoated steel panels using a variety of adhesives as listed in the table below. The films were tested for humidity resistance as described above.

| Adhesive | Family | Manufacturer | Humidity Results |
|---|---|---|---|
| DP 100 | Epoxy | 3 M¹² | OK |
| DP 100+ | Epoxy | 3 M¹² | OK |
| DP 105 | Epoxy | 3 M¹² | Adhesive FAIL: Lifting |
| DP 605 NS | Urethane | 3 M¹² | OK |
| DP 5003 | Urethane | 3 M¹² | OK |
| U 10 FL | Urethane | Loctite¹³ | 3: 1/2″ blisters/ |
| | | | bubbles to E-coat |
| 9460 F | Urethane | Loctite¹³ | 1: 1/4″ blister/ |
| | | | bubble to E-coat |
| E 00 CL | Epoxy | Loctite¹³ | Adhesve FAIL: Lifting |
| HC 6987 | 1 K | PPG¹⁴ | OK |

¹² 3M ™ Scotch Welt ™ adhesive available from 3M Company, St. Paul, MN
¹³ Henkle Corp., Gulph Mills, PA
¹⁴PPG Industries Inc., Pittsburgh, PA

Whereas the present invention has been described with reference to specific details of particular embodiments thereof, it is not intended that such details be regarded as limitations upon the scope of the invention except insofar as and to the extent that they are included in the accompanying claims.

We claim:

1. A composite article comprising:
(A) a carrier film having a first and second major surface; and
(B) a coating layer superimposed on the first surface of the film, the coating layer formed from a coating composition comprising an isocyanate-containing component and an amine-containing component.

2. The article according to claim 1, wherein the carrier film comprises a film selected from the group consisting of a thermoplastic material, a thermoset material, a metal foil, cellulosic paper, synthetic paper, and combinations thereof.

3. The article according to claim 2, wherein the thermoplastic material is selected from polyolefins, polyurethanes, polyesters, polyamides, polyureas, acrylics, and a blend of such materials.

4. The article according to claim 2, wherein the thermoset material is selected from the group consisting of polyurethanes, polyesters, polyamides, polyureas, polycarbonates, acrylic polymers, resins, and a blend of such materials.

5. The article according to claim 2, wherein the metal foil comprises aluminum, iron, copper, manganese, nickel, combinations thereof, and alloys thereof.

6. The article according to claim 1, wherein the carrier film has a thickness of at least 10 mil (254 μm).

7. The article according to claim 1, wherein the coating composition further comprises a silica and/or a clay.

8. The article according to claim 1, wherein the coating composition comprises a two-component composition, where a first component includes the isocyanate-containing component and a second component includes the amine-containing component.

9. The article according to claim 8, wherein the volume ratio of (A) to (B) is about 1:1.

10. The article according to claim 8, wherein the equivalent ratio of isocyanate groups to amine groups is greater than 1.

11. The article according to claim 8, wherein the coating composition further comprises a clay and/or a silica.

12. The article according to claim 1, wherein the isocyanate-containing component comprises isophorone diisocyanate.

13. The article according to claim 1, wherein the amine-containing component comprises an amine selected from the group consisting of primary amines, secondary amines, tertiary amines, and mixtures thereof.

14. The article according to claim 14, wherein the amine-containing component comprises about 20-80 wt. % primary amine and the balance secondary amine.

15. The article according to claim 7, wherein the clay is selected from the group consisting of montmorillonite clays, kaolin clays, attapulgite clays, sepiolite clay, and mixtures thereof.

16. The article according to claim 15, wherein the montmorillonite clay comprises bentonite.

17. The article according to claim 7, wherein the clay and/or silica is surface treated.

18. The article of claim 1, further comprising an adhesive layer superimposed on the second surface of the film.

19. The article of claim 18, wherein a temporary protective cover is superimposed over the adhesive layer.

20. A method of forming a polyurea coating on a carrier film comprising:
(I) selecting:
(A) an isocyanate-functional component including an isocyanate-containing material; and
(B) an amine-containing component including an amine-containing material;
wherein the volume ratio of (A) to (B) is about 1:1, and the equivalent ratio of isocyanate groups to amine groups is greater than 1,
(II) mixing (A) and (B) to form a reaction mixture; and
(III) applying the reaction mixture to a surface of the carrier film to form a polyurea coating thereon.
